(19) United States
(12) Patent Application Publication
(10) Pub. No.: US 2004/0128141 A1
(43) Pub. Date: Jul. 1, 2004

(54) System and program for reproducing information

(76) Inventors: Fumihiko Murase, Nagoya-city (JP); Mikio Sasaki, Kariya-city (JP)

Correspondence Address: POSZ & BETHARDS, PLC, 11250 ROGER BACON DRIVE, SUITE 10, RESTON, VA, 20190, US

(21) Appl. No.: 10/694,407

(22) Filed: Oct. 28, 2003

(30) Foreign Application Priority Data
Nov. 12, 2002 (JP) 2002-328213

(51) Int. Cl. G10L 11/00

(52) U.S. Cl. 704/275

(57) ABSTRACT

A speech inputted via a microphone is recognized by a speech recognition unit. Based on a recognition result, a dialogue control unit makes a music search unit search a music index database. When a search result includes plural musical compositions, a certain composition is designated from the plural musical compositions, based on an optional search method, to be immediately reproduced. The certain composition can be randomly designated. It can be also designated based on a frequency each composition was reproduced, a date and an hour when each composition is stored, a sale date, or a degree of matching to the inputted speech. This structure enables any musical composition to be immediately reproduced even without user's final input to designate only one of the musical compositions. This results in shortening a non-responding period where no music is being reproduced to enhance a comfort level of the user.

### CROSS REFERENCE TO RELATED APPLICATIONS

This application is based on and incorporates herein by reference Japanese Patent Application No. 2002-328213 filed on Nov. 12, 2002.

### FIELD OF THE INVENTION

The present invention relates to a reproduction system that designates, through using a speech, stored information such as musical composition information, moving picture information, or the like to reproduce.

### BACKGROUND OF THE INVENTION

A reproduction system that designates, through user's selection, one of pieces of stored musical composition information becomes popular. Here, those pieces of musical composition information are previously read out from compact disks and stored with including their titles or singers' names. However, it is a burden for the user to retrieve and designate the desired one among a lot of pieces of musical composition information (e.g., several hundreds, or several thousands pieces).

Several musical composition search systems (e.g., Patent references 1, 2, 3) are therefore proposed to relieve the burden of the user. These search a search table based on a music title, a singer name, a musical interval, or a rhythm inputted by speech to display on a display unit titles or the like of searched pieces of musical composition information. The user then designates one of the searched pieces through a remote controller or the like to reproduce the musical composition information.

However, in the above musical composition search systems, when plural pieces of information are designated as a search result, the user is furthermore required to select one of them to start to reproduce it. This therefore involves an additional input by the user for further narrowing down, such as a troublesome key manipulation, an additional speech input, or the like. It also involves an additional time interval due to the repeated procedures for finally determining the desired musical composition that is to be reproduced. Therefore, in particular, when a musical composition is newly searched just after an operational power being turned on, a state of no music being reproduced continues for a period. Here, the user gets stressed much enough to want any musical composition to be reproduced for the meantime.

[Patent reference 1: JP-A-H10-91176]

[Patent reference 2: JP-2897659 (U.S. Pat. No. 5,703,308)]

[Patent reference 3: JP-A-H9-293083]

### SUMMARY OF THE INVENTION

It is an object of the present invention to provide a reproduction system capable of suitably reproducing information according to a user's intention through a simple manipulation so as to enable the user to comfortably use it.

To achieve the above object, a reproduction system is provided with the following. A storing unit stores a plurality of pieces of information that can be reproduced. A reproducing unit reproduces a piece of information designated from the plurality of pieces of information stored in the storing unit. A speech inputting unit inputs a speech. When a speech is inputted, the inputted speech is recognized and decomposed into words. A search word is designated from the recognized words and a piece of information that corresponds to the search word is retrieved from the stored pieces of information. The reproducing unit is controlled for reproducing the retrieved piece of information. Here, when a given group of pieces of information that corresponds to the search word is retrieved, a given one from the given group of pieces of information is designated and the reproducing unit is controlled for instantaneously reproducing the given one of the given group. In the above structure, even when a piece of information that a user desires to reproduce cannot be reached in search processing, reproducing any piece of information is started. This results in shortening a period for which any information is not reproduced, so that user's intention that any information is being reproduced for the mean time is sufficed. A degree of comfort can be thereby enhanced.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing schematic structure of a reproduction system according to an embodiment of the present invention;

FIG. 2 is a flowchart diagram explaining dialogue processing according to the embodiment;

FIG. 3 is a flowchart diagram explaining search processing according to the embodiment;

FIG. 4A is a diagram showing a window image of SELECT LIST according to the embodiment;

FIG. 4B is a diagram showing a window image of PLAY LIST according to the embodiment; and

FIG. 4C is a diagram showing a window image of MESSAGE BOX according to the embodiment.

### DETAILED DESCRIPTION OF THE PREFERRED EMBODIMENTS

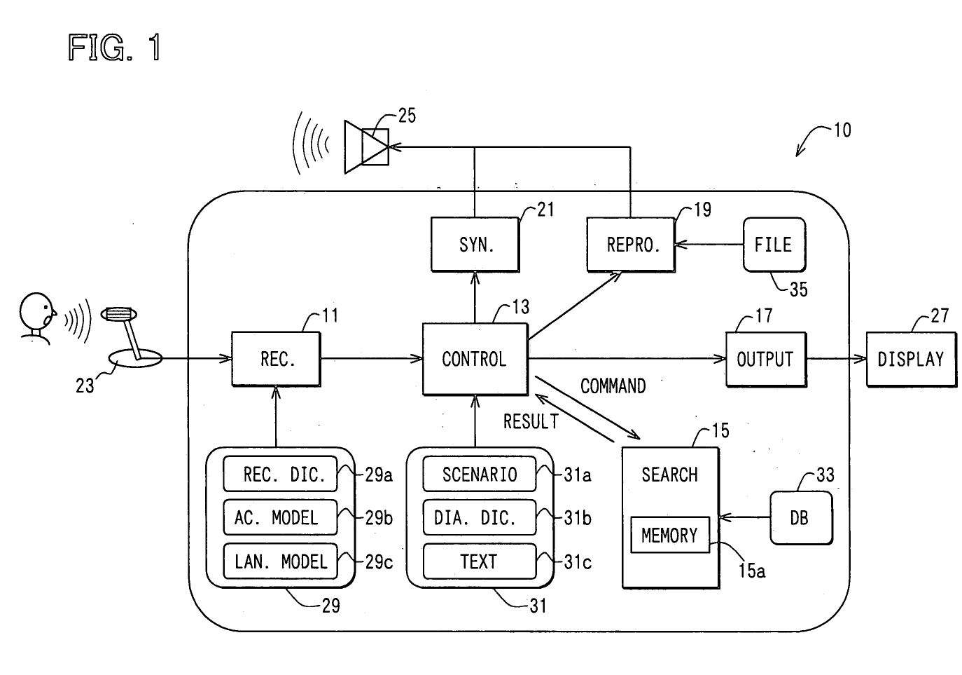

Structure of a reproduction system 10 of an embodiment of the present invention is shown in FIG. 1.

The reproduction system 10 for reproducing a musical composition is equipped with the following: a speech recognition unit 11; a dialogue control unit 13; a music search unit 15; a message output unit 17; a music reproduction unit 19; a speech synthesis unit 21; a microphone 23; a speaker 25; a display 27; or the like. Of these the speech recognition unit 11, the dialogue control unit 13, the music search unit 15, the message output unit 17, the music reproduction unit 19, and the speech synthesis unit 21 are mainly formed in a known micro-computer. The micro-computer includes CPU, ROM, RAM, I/O, and a bus line that connects the preceding components. Various processing is executed based on a program stored in the ROM and RAM.

The speech recognition unit 11 analyzes and recognizes, using speech recognition data 29, a speech inputted via the microphone 23 to send a recognition result to the dialogue control unit 13. As the dialogue control unit 13 receives the recognition result, it commands the music search unit 15 to execute a search based on dialogue control data 31 to receive a search result. Based on the search result, the dialogue control unit 13 then commands the music reproduction unit 19a to reproduce. Furthermore, the dialogue control unit 13 sends a text to the speech synthesis unit 21 for notifying various messages to a user.

The music search unit 15 retrieves using a music index database 33 a piece of musical composition information to send a search result to the dialogue control unit 13 along with storing the search result in a search result storing memory 15a. Here, the pieces of musical composition information can be compressed by compression technology of MPEG-1 Audio Layer 3 (MP3) and stored as a music file. The speech synthesis unit 21 synthesizes a synthesized speech based on the text sent by the dialogue control unit 13 to output the synthesized speech to the speaker 25.

The music reproduction unit 19 reproduces using a music file 35 the piece of musical composition information to output it via the speaker 25. The message output unit 17 outputs to the display 27 the message sent by the dialogue control unit 13.

The above-mentioned speech recognition data 29, dialogue control data 31, music index database 33, and the music file 35 are stored in a hard disk (not shown).

An operation of each unit will be explained below.

(1) Speech Recognition Unit 11

The speech recognition unit 11 receives various speeches from a user via the microphone 23 as voice signals. The user can speak a nature word that means a word being naturally spoken. The user can speak nature words such as “play ‘xxx’ of ‘yyy’” or “play the recent song.” Here, “XXX” indicates an artist name, while “yyy” indicates a title of a musical composition.

As the speech recognition unit 11 receives the voice signals from the microphone 23, it executes speech recognition using the speech recognition data 29, i.e., a recognition dictionary 29a, acoustic models 29b, and language models 29c to send, if the recognition is successful, a recognition result to the dialogue control unit 13. The recognition dictionary 29a, acoustic models 29b, and language models 29c will be explained below.

The recognition dictionary 29a is formed of a word dictionary and relation information between words. The word dictionary includes the following: a singer name; an album name, a musical composition name; a genre name, a command (reproducing, stopping, heading, repeating, randomly selecting, music number selecting, or the like); music atmosphere (being cheerful, being slow-paced, being lilting, or the like); additional information (a film, a TV drama, or a commercial using the musical composition); an unnecessary word (gee, wow, or the like); or the like. The relation information between words, being information of combination of words, indicates whether words have relation with one another. The speech recognition unit 11 determines whether combination of candidate words for a recognition result is included in the relation information between words. Based on this determination result, the speech recognition unit changes a degree of likelihood of the candidate words for the recognition result or eliminates the candidate words for the recognition result.

The relation information between words can be formed using a list format or a vector format. In the list format, words relating to a search word or signs distinguishing the search word are listed. For instance, there is a case where “Musical composition 1 of Singer 1” and “Musical composition 2 of Singer 2” are present while “Musical composition 2 of Singer 1” and “Musical composition 1 of Singer 2” are not present. In this case, a list of “Singer 1” includes at least “Musical composition 1” but not “Musical composition 2.”. For instance, the list of “Singer 1” includes “Musical composition 1,” “Musical composition 3,” “Musical composition 4,” and the like. By contrast, a list of “Singer 2” includes at least “Musical composition 2” but not “Musical composition 1.” For instance, the list of “Singer 2” includes “Musical composition 2,”“Musical composition 5,” “Musical composition 6,” and the like. Furthermore, not only a list of musical compositions based on a singer but also a list of singers based on a musical composition can be prepared.

In the vector format, all words are previously hierarchically ranked and whether a search word relates to each word or not is indicated by a bit row. In detail, the first rank and the second rank are assigned to Musical composition 1 and Musical composition 2, respectively. A vector of “Singer 1” has a bit row of [1,0, . . . ], while a vector of “Singer 2” has a bit row of [0,1, . . . ]. In this vector format, not only a vector of a singer based on a musical composition, but also a vector of a musical composition based on a singer can be prepared.

In the acoustic models 29b, various human voice patterns are registered. Comparing inputted voice signals with the registered voice patterns leads to producing a text. Furthermore, it is desired that additional voice patterns can be added for accurately recognizing user's voices. The language models 29c include grammar information used in decomposing the recognized-voice signals into words.

(2) Dialogue Control Unit 13

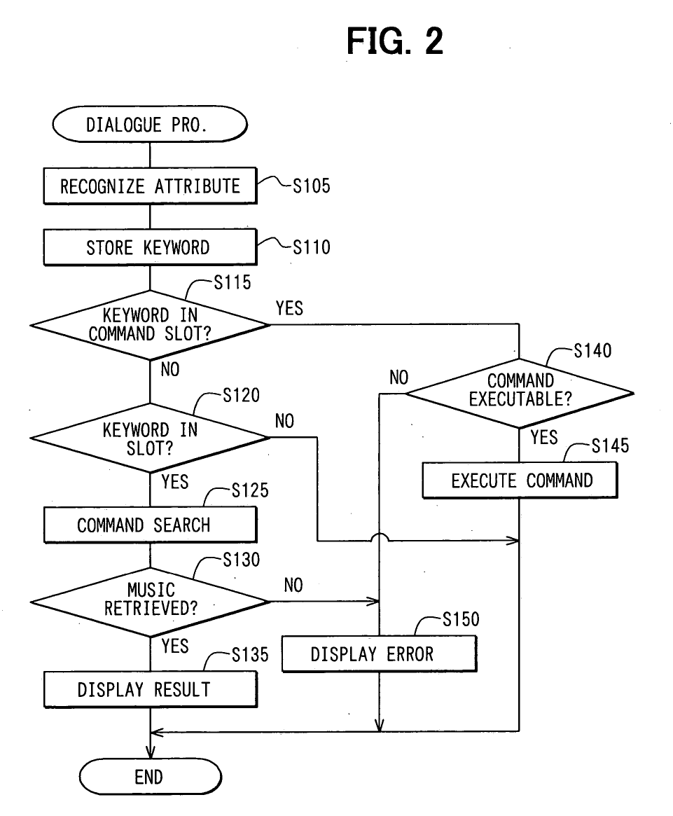

The dialogue control unit 13 executes dialogue processing using dialogue control data 31 constituted by a dialogue scenario group 31a, a dialogue dictionary 31b, and utterance texts 31c. The dialogue scenario group 31a is data having various dialogue patterns. The dialogue dictionary 31b is data having, for each word, an attribute (a part of speech, a meaning, or the like). The utterance texts 31c are text data having detailed utterance contents of synthesized voices uttered in a dialogue. The dialogue processing will be explained with reference to FIG. 2. The dialogue processing is started when the dialogue control unit 13 receives a recognition result from the speech recognition unit 11.

At Step 105, an attribute of each of words that constitute the recognition result is recognized using the dialogue dictionary 31b. At Step 110, as search words keywords are designated for searching for a musical composition or for controlling the reproduction system 10. The keywords are then stored in relating slots which is a formal vessel. The relating slots include a search slot for being stored with a keyword for searching for a musical composition and a command slot for being stored with a keyword for controlling the reproduction system 10. The search slot furthermore includes a primary slot (i.e., a singer name slot, an album name slot, or a music name slot) for being stored with a keyword for preferentially searching (or a priority search) and a usual slot for being stored with a keyword other than the keyword for preferentially searching.

Each slot is designed as having priority. When a certain keyword can be stored in plural slots (being a musical composition name and an album name), the certain keyword is stored in a slot having higher priority. In a state where a command can be accepted, a command slot has higher priority. For instance, in a case where “stop” is uttered, a keyword of “stop” is stored in a command slot when a musical composition is being reproduced. The keyword of “stop” is stored in a music name slot when no musical composition is being reproduced.

At Step 115, it is determined whether the command slot is stored with a keyword. When the command slot is determined to be stored with a keyword, the processing proceeds to Step 140. Otherwise, the processing proceeds to Step 120. At Step 140, it is determined whether the keyword in the command slot is executable. Being executable means that, for instance, a keyword indicating stopping of reproducing a musical composition is stored in the command slot when stopping of reproducing can be executable. By contrast, when stopping of reproducing cannot be executable, it is determined to be inexecutable. When it is determined to be executable, the processing proceeds to Step 145. Otherwise, the processing proceeds to Step 150.

At Step 145, a command being executable is sent to the music reproduction unit 19 for making the music reproduction unit 19 execute the command, and the dialogue processing is terminated. By contrast, at Step 150, a command being inexecutable is sent to the message output unit 17 for making the message output unit 17 display on the display 27 that the inputted command cannot be executed. Simultaneously, a command is sent to the speech synthesis unit 21 for making the speech synthesis unit 21 output a synthesized voice indicating that the inputted command cannot be executed. The dialogue processing is then terminated.

At Step 120, where the processing proceeds when it is determined that the command slot is stored with no keyword, it is determined whether at least one slot other than the command slot has a keyword. When at least one slot has a keyword, the processing proceeds to Step 125. Otherwise, the dialogue processing is terminated.

At Step 125, a search command, with information including the keyword stored in the slot and the slot itself, is sent to the music search unit 15 so that the music search unit 15 is made to execute search processing. This search processing will be explained later. As the search processing of the music search unit 15 is terminated, a search result is received from the music search unit 15. At Step 130, it is determined whether the search result includes at least one musical composition. When at least one musical composition is included, the processing proceeds to Step 135. Otherwise, the processing proceeds to Step 150.

At Step 135, a command is sent to the message output unit 17 so that the message output unit 17 is made to display on the display 27 a list of the search result. Simultaneously, a command is sent to the music reproduction unit 19 so that the music reproduction unit 19 is made to reproduce the highest ranked musical composition on the list. Here, when an album is listed in the highest rank, the first track musical composition of the album is to be reproduced. The processing is then terminated.

At Step 150, a command is sent to the message output unit 17 so that the message output unit 17 is made to display on the display 27 that no related musical composition is retrieved. Simultaneously, a command is sent to the speech synthesis unit 21 so that the speech synthesis unit 21 is made to output a synthesized voice indicating that no related musical composition is retrieved. Here, the dialogue scenario group 31a and the utterance texts 31c are used. The dialogue processing is then terminated.

(3) Music Search Unit 15

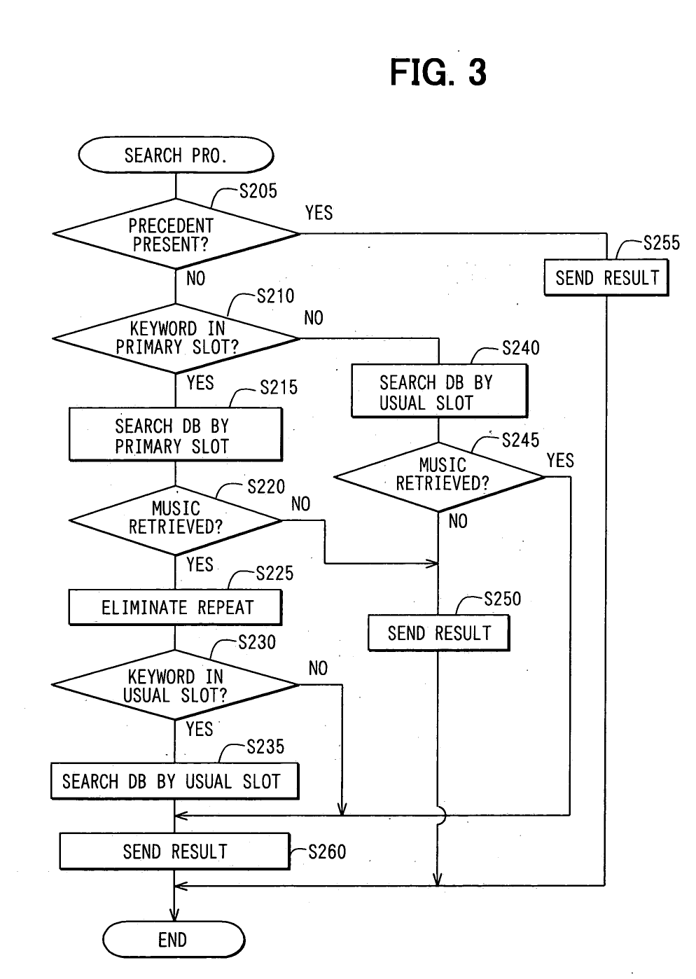

The music search unit 15 starts the search processing when it receives the search command from the dialogue control unit 13. The search processing will be explained with reference to FIG. 3.

At Step 205, it is determined whether the preceding search result stored in the search result storing memory 15a corresponds to the search command received from the dialogue control unit 13. When the preceding search result corresponds to the search command, the processing proceeds to Step 255. Otherwise, the processing proceeds to Step 210. Here, when the search result storing memory 15a is clearly stored with no preceding search result, the processing directly proceeds to Step 210 with skipping Step 205.

At Step 255, the corresponding musical composition of the preceding search result is stored as a search result this time in the search result storing memory 15a. Simultaneously, the search result is sent to the dialogue control unit 13. The processing is then terminated.

At Step 210, it is determined whether a primary slot is stored with at least one keyword. When the primary slot is stored with at least one keyword, the processing proceeds to Step 215. Otherwise, the processing proceeds to Step 240.

At Step 215, the music index database 33 is searched for the keyword in the primary slot. The music index database 33 is formed of information being described by a description language such as XML. The information includes the following.

Singer names and their pronunciations

Nick names of Singers and their pronunciations

Album names and their pronunciations

Musical compositions and their pronunciations

Track numbers of albums

Instrumental performance times

Track numbers of musical compositions

File names of musical compositions

storing paths of musical composition files

Histories of reproducing (frequencies, periods)

Atmospheres of musical compositions

Additional information of musical compositions

Sale dates of musical compositions

At subsequent Step 220, it is determined whether a musical composition is retrieved after the search processing. When at least one musical composition is retrieved, the processing proceeds to Step 225. Otherwise, the processing proceeds to Step 250.

At Step 250, a search result indicating that no musical composition is retrieved is sent to the dialogue control unit 13. The processing is then terminated. At Step 225, when the same musical composition of the same singer is repeatedly present within the search result, a repeated portion is eliminated. At Step 230, it is determined whether a usual slot is stored with a keyword. When the usual slot is stored with a keyword, the processing proceeds to Step 235. Otherwise, the processing proceeds to Step 260.

At Step 235, the search result is sorted using the keyword in the usual slot. The processing then proceeds to Step 260. At Step 260, the search result is stored in the search result storing memory 15a along with being sent to the dialogue control unit 13. The processing is then terminated.

At Step 240, where the processing proceeds when it is determined that the primary slot is stored with no keyword, the music index database 33 is searched for the keyword stored in the usual slot. At subsequent Step 245, it is determined whether at least one musical composition is retrieved after the search processing. When at least one musical composition is retrieved, the processing proceeds to Step 260. Otherwise, the processing proceeds to Step 250.

(4) Message Output Unit 17

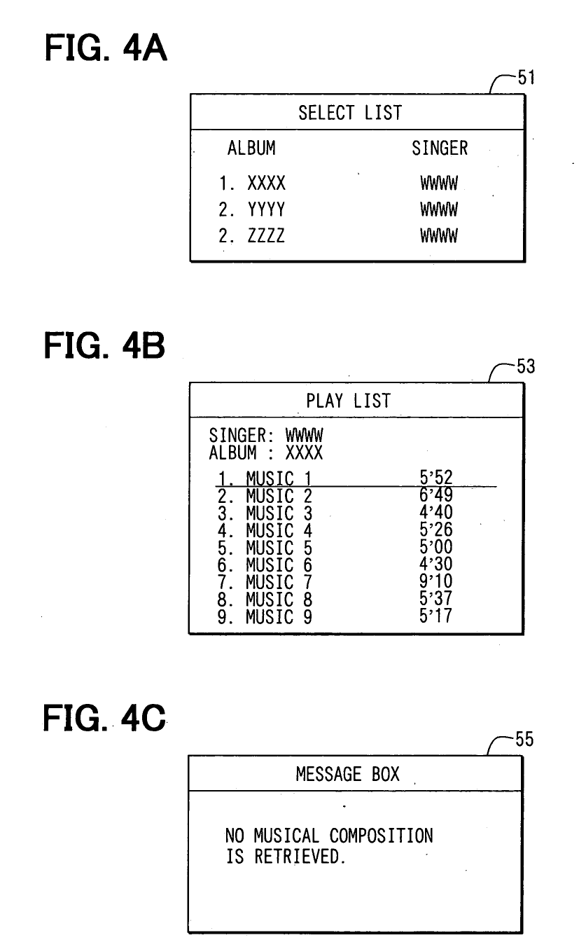

The message output unit 17 generates and outputs a window displayed on the display 27. An instance of processing from a user's request of reproducing to outputting of the window will be explained with reference to FIGS. 4A to 4C.

For instance, a user inputs “reproduce a musical composition of ‘WWWW’ ” via the microphone 23. Here, “WWWW” is a singer name. Through the processing by the speech recognition unit 11, the dialogue control unit 13, and the music search unit 15, an album of the singer “WWWW” is retrieved and a list showing the search result (SELECT LIST) is generated. As shown in FIG. 4A, a SELECT LIST window 51 is outputted. The SELECT LIST window 51 includes three pairs of an album name and a singer name, but the numbers of pairs are changeable according to the search result. When a musical composition is included in a single, a name of the musical composition is displayed on the list instead of a name of the album.

After the SELECT LIST window 51 is displayed, musical compositions included in the first ranked album on the SELECT LIST window 51 are developed and shown in a PLAY LIST window 53. The PLAY LIST window 53 includes a singer name, an album name, track numbers, musical composition names, and performing periods. Here, as soon as the message output unit 17 displays the PLAY LIST window 53, the music reproduction unit 19 starts to reproduce the first ranked musical composition on PLAY LIST.

The above three windows can be simultaneously displayed on the display 27 when the display 27 has sufficient dimensions for showing the three windows. However, when the display 27 has not sufficient dimensions, for instance, it can be designed that the SELECT LIST window 51 disappears in a certain period and only the PLAY LIST window 53 preferentially remains on the display 27. Furthermore, the SELECT LIST window 51 can be displayed again any time the user requests it.

When no musical composition is retrieved through the search processing, a message of “no musical composition is retrieved” is displayed on a MESSAGE BOX window 55, as shown in FIG. 4C.

(5) Music Reproduction Unit 19

The music reproduction unit 19 operates the music file 35 being assigned to by the dialogue control unit 13. The music file 35 is compressed by a suitable compression format.

(6) Speech Synthesis Unit 21

The speech synthesis unit 21 outputs via the speaker 25, using a synthesized voice, a text for reading sent from the dialogue control unit 13. The main units of the reproduction system 10 are explained above regarding their structures and operations.

Instances for dialogues realized by the dialogue processing according to user's utterance will be explained from (a) to (r).

(a) When, of the primary slot, only a singer name slot is stored with a keyword:

All the albums of the singer name that were successes and all the musical compositions included in all the albums become targets for reproducing. On the SELECT LIST window 51, album names and the singer name are shown. A musical composition is reproduced in order from the first ranked album on the SELECT LIST window 51. On the other hand, on the PLAY LIST window 53, a name of an album including the musical composition being reproduced and names of other musical compositions included in the album are shown.

(b) When, of the primary slot, only an album name slot or only both a singer name slot and an album name slot are stored with a keyword:

When only the album name slot is stored with a keyword, the music search unit 15 executes search processing using the keyword stored in the album name slot. Here, a different singer may have the same album name, so that all different albums having the same album name become search targets. When both a singer name slot and an album name slot are stored with a keyword, one album is usually designated and therefore becomes a search target. When a singer has a musical composition and an album, both of which have the same name, a keyword relating to the same tame is stored in an album name slot. Namely, an album name slot is preferentially selected for storing the keyword on the SELECT LIST window 51, an album name and a singer name are displayed. On the PLAY LIST window 53, names of the musical compositions included in the first ranked album on the SELECT LIST window 51 are displayed.

(c) When, of the primary slot, a music name slot is stored with a keyword (it is not considered whether other slots are stored with a keyword):

When only one musical composition is retrieved, a name of the musical composition and a name of a singer are displayed on the SELECT LIST window 51. The same name of the musical composition and the same name of the singer are displayed on the PLAY LIST window 53.

When different albums of the same singer include the same musical composition, one of the different albums is displayed on the SELECT LIST window 51. When only a musical composition name is designated by the user and different singers have the same musical composition name, all pairs of the retrieved musical composition name and a corresponding singer name are displayed on the SELECT LIST window 51. On the PLAY LIST window 53, the first ranked pair of the musical composition name and singer name on the SELECT LIST is displayed.

(d) When no primary slot is stored with a keyword:

Based on the usual slot, the music search unit 15 executes search processing. All musical compositions or albums that are retrieved are displayed on the SELECT window 53 or the PLAY LIST window 53.

(e) When “subsequent musical composition” is inputted as a command:

A musical composition that is ranked on PLAY LIST subsequently to a musical composition being reproduced is to be reproduced.

When a presently reproduced musical composition corresponds to the last rank on PLAY LIST and SELECT LIST includes plural ranks, a rank on SELECT LIST subsequent to a rank on SELECT LIST corresponding to the presently reproduced musical composition is stored in PLAY LIST. The first ranked musical composition of PLAY LIST is then reproduced. However, when the rank on SELECT LIST corresponding to the presently reproduced musical composition is the last rank, the first rank on SELECT LIST is stored in PLAY LIST. The first ranked musical composition of PLAY LIST is then reproduced. By contrast, when there are no other ranks on SELECT LIST, the first rank on PLAY LIST is then reproduced.

(f) When “preceding musical composition” is inputted as a command:

A musical composition that is ranked on PLAY LIST precedently to a musical composition being reproduced is to be reproduced.

When a presently reproduced musical composition corresponds to the first rank on PLAY LIST and SELECT LIST includes plural ranks, a rank on SELECT LIST precedent to a rank on SELECT LIST corresponding to the presently reproduced musical composition is stored in PLAY LIST. The last ranked musical composition of PLAY LIST is then reproduced. However, when the rank on SELECT LIST corresponding to the presently reproduced musical composition is the first rank, the last rank on SELECT LIST is stored in PLAY LIST. The last ranked musical composition of PLAY LIST is then reproduced. By contrast, when there are no other ranks on SELECT LIST, the last rank on PLAY LIST is then reproduced.

(g) When a command indicating a track number (e.g., first, second, third, fourth, fifth, or the like) is inputted:

A musical composition corresponding to the designated track number is reproduced.

When PLAY LIST includes only one rank (by inputting a musical composition name), a musical composition corresponding to a rank number on SELECT LIST is reproduced.

When no relating musical composition is present, “no musical composition having X numbered musical composition is present” is outputted using a synthesized voice via the speaker 25.

(h) When a command indicating “another musical composition” or “different musical composition” is inputted:

A musical composition different from a musical composition being reproduced is randomly designated within PLAY LIST and reproduced.

When no other musical compositions are present on PLAY LIST (by inputting a musical composition name) and SELECT LIST includes plural musical compositions, another musical composition is randomly designated from SELECT LIST and reproduced. When SELECT LIST includes only one musical composition, no additional processing is executed.

(i) When a command indicating “subsequent album” is inputted:

When SELECT LIST includes plural albums, the subsequent album is stored on PLAY LIST and the first ranked musical composition is reproduced. When no subsequent ranked album is present, the first ranked album is stored in PLAY LIST and the first ranked musical composition is reproduced.

When SELECT LIST includes only one album, no additional processing is executed.

(j) When a command indicating “precedent album” is inputted:

When SELECT LIST includes plural albums, the precedent album is stored on PLAY LIST and the first ranked musical composition is reproduced. When no precedent ranked album is present, the last ranked album is stored in PLAY LIST and the last ranked musical composition is reproduced.

When SELECT LIST includes only one album, no additional processing is executed.

(k) When a command indicating an album number (i.e., “third album”) is inputted:

The first ranked musical composition on the designated album is reproduced.

When the designated album is not present, “x numbered album is not present” is outputted using a synthesized voice via the speaker 25.

(l) When a command indicating “another album” or “different album” is inputted:

When SELECT LIST includes plural albums, an album different from an album being presently reproduced is randomly designated to be stored on PLAY LIST. The first ranked musical composition of the designated album is then reproduced.

When SELECT LIST includes only one album, search processing is executed using the same singer name being presently reproduced. When other albums of the same singer are retrieved, one album is randomly designated to be stored on PLAY LIST. The first ranked musical composition is then reproduced. When no other albums are retrieved, no additional processing is executed.

(m) When a command indicating “subsequent singer”, “precedent singer”, “another singer,” or “x numbered signer” is inputted:

It is only effective when SELECT LIST includes a different singer's musical composition or album having the same name being presently reproduced. Namely, it is a case where a musical composition is being reproduced through a dialogue in which a keyword is stored in only a music name slot or only an album name slot. The relating musical composition or album is stored in PLAY LIST and the first ranked musical composition is then reproduced. When the above condition is not effected, no additional processing is executed.

(n) When a command indicating “subsequent list” or “precedent list” is inputted:

When a search result includes plural musical compositions or albums and dimensions of the display 27 cannot include all the musical compositions or albums, the remaining portion being not displayed on the dimensions is to be displayed by scrolling. For instance, it is supposed that the dimensions include only three ranks and the first list having the first to third ranks is presently displayed. Here, when “subsequent list” is inputted, a list having the fourth to sixth ranks is displayed. By contrast, when “precedent list” is inputted, a list having the fifth to seventh (last) ranks is displayed. Here, a musical composition being presently reproduced is not changed and PLAY LIST is not changed during the above processing.

When all of the search result can be shown in the dimensions of the display 27, no additional processing is executed.

When a musical composition is being reproduced based on MYLIST to be explained later, the first ranked musical composition on the subsequent list or precedent list, if it is present, is reproduced.

(o) When a command indicating a list number (e.g., third list) is inputted:

The first ranked musical composition on the designated list is reproduced.

When the designated list is not present, “x numbered list is not present” is outputted using a synthesized voice via the microphone 25.

(p) When a command indicating “different” is inputted:

It is only effective when SELECT LIST includes plural musical compositions or albums. A list subsequent to a list shown on SELECT LIST is stored on PLAY LIST and the first musical composition is reproduced.

(q) When a command indicating “album including this composition” is inputted:

It is effective only when PLAY LIST is not formed by being developed from an album but formed of only one musical composition. Namely, it is a case where a musical composition is inputted. An album that includes the musical composition being presently reproduced is searched for and a search result is stored on SELECT LIST. When plural albums are stored on SELECT LIST, the first ranked album is stored in PLAY LIST and the first ranked musical composition is then reproduced.

(r) When a command indicating “subsequent” or “precedent” is inputted:

When PLAY LIST is displayed, a musical composition subsequent (precedent) to a musical composition being presently reproduced is reproduced. When SELECT LIST is displayed instead of PLAY LIST, a list subsequent (precedent) to SELECT LIST is stored on PLAY LIST and the first ranked musical composition is reproduced.

In the next place, other functions will be explained below. The functions are started by user's speech input.

(i) Search Function for Stored Musical Compositions

When a user does not know stored musical compositions, the user retrieves and reproduces a target musical composition or album through dialogue using this function. An utterance such as “album search” or “musical composition search” can start processing. Instances will be explained below.

User: “Album search”

Reproduction system 10: “Stored artists are as follows: ‘AAA,’ ‘BBB,’ and “CCC.’ Which do you select?”

User: “AAA”

Reproduction system 10: “Albums of Artist ‘AAA’ are ‘DDD,’ ‘EEE,’ and ‘FFF.’ Which do you select?”

User: “DDD”

Reproduction system 10: “‘DDD’ is reproduced,” or “Album ‘DDD’ has musical compositions of ‘GGG,’ ‘HHH,’ and ‘III.’ Which do you select?”

User: “GGG”

Reproduction system 10: “‘GGG’ is reproduced.

(ii) MY-TOP-TEN Reproducing Function

Histories of reproducing are stored. Using the stored histories, musical compositions are designated from the first most frequently reproduced musical composition to the given numbered one (e.g., tenth) as MY-TOP-TEN. An utterance such as “my top ten” can start this function, so that MY-TOP-TEN can be automatically reproduced.

(iii) MYLIST Reproducing Function

MYLIST is a list where favorite musical compositions of a user are registered. MYLIST is registered by the user via voice. When the reproduction system 10 has a unit enabling key manipulation or touch manipulation, the unit can be used for listing up MYLIST. When plural MYLISTs are present, all MYLISTs are stored on SELECT LIST. One of them is then randomly designated to be stored on PLAY LIST and the first ranked musical composition is reproduced. An utterance such as my list” or a name of MYLIST can start this function.

(iv) All Musical Compositions Random Reproducing Function

All musical compositions stored in a hard disk are randomly reproduced.

(v) Singer's all Musical Compositions Random Reproducing Function

When the user designates a certain singer, all musical compositions of the certain singer stored in the hard disk are randomly reproduced.

(vi) Newest Musical Compositions Reproducing Function

Based on stored dates when musical compositions are stored in the hard disk or sale dates which are stored in the music index database, latest musical compositions are reproduced. An utterance such as “reproduce a new musical composition” can start this function.

As explained above, according to the reproduction system 10, even when a user does not finally determine one musical composition, immediately reproducing any one of musical compositions can be started. A period where any musical composition is not being reproduced is thereby shortened. This results in enhancing a comfort level.

(Others)

(1) In the above embodiment, musical compositions are reproduced by the reproduction system. However, an item being reproduced can be a moving picture (e.g., a movie, a promotion video, or the like), a voice (e.g., reading of a novel, comic storytelling, or the like), or a text (e.g., a newspaper article, a magazine article, or the like). When these items are reproduced, the same effect can be obtained.

(2) When the speech recognition unit 11 has plural candidates for a recognition result, it can send to the dialogue control unit 13 some of the plural candidates. In this case, the dialogue control unit 13 prepares plural slots for the same kind to search for an item including any one of the plural candidates (keywords). For instance, when the candidate singers are “ABC” and “AVC,” a so-called OR search can be executed using both the singer names. In this case, even when recognition itself is not so accurate, a probability of retrieving a musical composition that is desired by a user can remain high since resembling words can be effectively used for the search processing.

(3) The reproduction system 10 is desirably mounted on a vehicle. When the reproduction system 10 is mounted on the vehicle, the reproduction system 10 can substitute a display of a car navigation for the display 27. Furthermore, availability of voice input for controlling the system leads to securing safety during the driving.

(4) When information being, reproduced is musical composition information and a reproduction system is provided in a vehicle, the invention can be especially useful. It is because a user typically enjoys reproducing a musical composition as background music during the driving. Furthermore, shortening a period for which any musical composition is not being reproduced reduces stress of the user during the driving, which results in securing safety during the driving.

(5) The above-mentioned processing can be included in a program. Here, the program can be stored in a computer program product including a computer usable medium such as a magnetic disk, an optical magnetic disk, a memory card, a compact disk, a DVD, or the like. The program can be thereby loaded in a computer, when needed. Furthermore, the program can be loaded in a computer via a communications network, so that updating the program can be easily executed.

(6) At Step 135 in FIG. 2, when the search result includes various musical compositions or various albums, a certain musical composition is designated from the search result as a reproduced candidate for being reproduced by adopting one of various optional search methods. For instance, the reproduced candidate can be randomly designated from the search result. The reproduced candidate can be designated based on a frequency each musical composition of the search result was reproduced. The reproduced candidate can be designated based on a date and an hour when each musical composition of the search result is stored. The reproduced candidate can be designated based on a sale date of each musical composition of the search result. Furthermore, the reproduced candidate can be designated from the search result based on a degree of matching to a search word. Here, the degree of matching to the search word is evaluated with a more meticulous criterion than a criterion with which the search result is previously retrieved so that one reproduced candidate can be designated from the search result.

It will be obvious to those skilled in the art that various changes may be made in the above-described embodiments of the present invention. However, the scope of the present invention should be determined by the following claims.

What is claimed is:

1. A reproduction system comprising:
a storing unit for storing a plurality of pieces of information that can be reproduced;
a reproducing unit for reproducing a piece of information designated from the plurality of pieces of information stored in the storing unit;
a speech recognizing unit for inputting a speech and for recognizing and decomposing the inputted speech into words; and
a control unit for designating a search word from the recognized words sent by the speech recognizing unit, retrieving a piece of information that corresponds to the search word from the stored pieces of information, and controlling the reproducing unit for reproducing the retrieved piece of information,
wherein, when the control unit retrieves a given group of pieces of information that corresponds to the search word, wherein the given group of pieces of information is a subset of the plurality of pieces of information, the control unit designates a given one from the given group of pieces of information to instantaneously control the reproducing unit for reproducing the given one of the given group.

2. The reproduction system according to claim 1,
wherein the speech recognition unit accepts a subsequent speech after the reproducing unit starts reproducing the given one, and
wherein the control unit retrieves a certain subgroup of pieces of information based on the inputted subsequent speech, wherein the certain subgroup of pieces of information is a subset of the given group, designates a certain one of the certain subgroup, and controls the reproduction unit for stopping reproducing the given one and then instantaneously starting reproducing the certain one instead of the given one.

3. The reproduction system according to claim 1,
wherein, when the control unit designates the given one from the given group of pieces of information, the given one is designated based on a degree of matching the search word,
wherein the degree of matching the search word is evaluated with a more meticulous criterion than a criterion with which the given group are retrieved so that at least the given one can be designated from the given group.

4. The reproduction system according to claim 1,
wherein, when the control unit designates the given one from the given group of pieces of information, the given one is randomly designated from the given group.

5. The reproduction system according to claim 1,
wherein, when the control unit designates the given one from the given group of pieces of information, the given one is designated from the given group based on a frequency the given one was reproduced.

6. The reproduction system according to claim 1,
wherein the storing unit additionally stores a date and an hour when each of the plurality of pieces of information is stored, and
wherein, when the control unit designates the given one from the given group of pieces of information, the given one is designated from the given group based on the stored dates and hours.

7. The reproduction system according to claim 1,
wherein the storing unit additionally stores sale dates of the plurality of pieces of information, and
wherein, when the control unit designates the given one of the given group of pieces of information, the given one is designated from the given group based on the stored sale dates.

8. The reproduction system according to claim 1,
wherein, when one of the recognized words indicates an operational command for operating the reproduction system, the control unit executes the operational command, and
wherein, when all the recognized words do not indicate the operational command, the control unit recognizes all the recognized words as candidates from which the search word is designated.

9. The reproduction system according to claim 8,
wherein the operational command includes a listing command for listing up a list for reproducing and a reproducing command for reproducing based on the list,
wherein, when the indicated operational command is the listing command and a piece of information is being reproduced, the control unit registers in the list the piece of information that is being reproduced, and
wherein, when the indicated operational command is the reproducing command, the control unit reproduces a piece of information in the list based on the list.

10. The reproduction system according to claim 1,
wherein, when the speech recognizing unit has a plurality of candidates for one of the recognized words, the speech recognizing unit designates a given group of candidates from the plurality of candidates, wherein the given group of candidates is a subset of the plurality of candidates,
wherein the control unit designates a plurality of search word candidates from the given group of candidates received from the speech recognition unit, and
wherein the control unit retrieves a certain group of pieces of information that corresponds to at least one of the plurality of search word candidates from the stored pieces of information.

11. The reproduction system according to claim 1, further comprising:
a combination information storing unit for storing a plurality of pieces of combination information relating to combination among words,
wherein, when combination among the recognized words is not included in the combination information storing unit, the speech recognizing unit executes one of never sending the recognized words to the control unit and sending the recognized words along with information indicating that a degree of likelihood of the recognized words to the inputted speech is low.

12. The reproduction system according to claim 1, wherein each of the plurality of pieces of information stored in the storing unit includes information of a musical composition.

13. The reproduction system according to claim 1,
wherein the reproduction system is provided in a vehicle.

14. A computer program product that includes a computer usable medium and is used in a reproduction system that includes:
a storing unit for storing a plurality of pieces of information that can be reproduced;
a reproducing unit for reproducing a piece of information designated from the plurality of pieces of information stored in the storing unit; and
a speech inputting unit for inputting a speech,
the computer program product comprising at least one of instruction groups:
a first instruction group for recognizing and decomposing the inputted speech into words; and
a second instruction group for designating a search word from the recognized words, retrieving a piece of information that corresponds to the search word from the stored pieces of information, and controlling the reproducing unit for reproducing the retrieved piece of information,
wherein, when a given group of pieces of information that corresponds to the search word is retrieved, wherein the given group of pieces of information is a subset of the plurality of pieces of information, a given one from the given group of pieces of information is designated and the reproducing unit is instantaneously controlled for reproducing the given one of the given group.

15. A reproducing method used in a reproduction system that includes:
a storing unit for storing a plurality of pieces of information that can be reproduced;
a reproducing unit for reproducing a piece of information designated from the plurality of pieces of information stored in the storing unit; and
a speech inputting unit for inputting a speech,
the reproducing method comprising:
recognizing and decomposing the inputted speech into words;
designating a search word from the recognized words;
retrieving a piece of information that corresponds to the search word from the stored pieces of information; and
controlling the reproducing unit for reproducing the retrieved piece of information,
wherein, when a given group of pieces of information that corresponds to the search word is retrieved, wherein the given group of pieces of information is a subset of the plurality of pieces of information, a given one from the given group of pieces of information is designated and the reproducing unit is instantaneously controlled for reproducing the given one of the given group.

16. A reproduction system comprising:
a storing unit for storing a plurality of pieces of information that can be reproduced;
a reproducing unit for reproducing a piece of information designated from the plurality of pieces of information stored in the storing unit;
a speech recognizing unit for inputting a speech and for recognizing and decomposing the inputted speech into words;
a control unit for designating a search word from the recognized words sent by the speech recognizing unit, retrieving a piece of information that corresponds to the search word from the stored pieces of information, and controlling the reproducing unit for reproducing the retrieved piece of information; and
a combination information storing unit for storing a plurality of pieces of combination information relating to combination among words,
wherein, when combination among the recognized words is not included in the combination information storing unit, the speech recognizing unit executes one of never sending the recognized words to the control unit and sending the recognized words along with information indicating that a degree of likelihood of the recognized words to the inputted speech is low.

17. The reproduction system according to claim 15,
wherein the reproduction system is provided in a vehicle.

18. A computer program product that includes a computer usable medium and is used in a reproduction system that includes:
a storing unit for storing a plurality of pieces of information that can be reproduced;
a combination information storing unit for storing a plurality of pieces of combination information relating to combination of words;
a reproducing unit for reproducing a piece of information designated from the plurality of pieces of information stored in the storing unit; and
a speech inputting unit for inputting a speech,
the computer program product comprising at least one of instruction groups:
a first instruction group for recognizing and decomposing the inputted speech into words, and determining whether combination among the recognized words is included in the combination information storing unit,
wherein, when the combination among the recognized words is included in the combination information storing unit, the recognized words are recognized as final recognized words,
wherein, when the combination among the recognized words is not included in the combination information storing unit, the recognized words are dealt with by one of two procedures, wherein in a first procedure the recognized words become tentative recognized words having information indicating that a degree of likelihood of the recognized words to the inputted speech is low, wherein in a second procedure the recognized words do not become the final recognized words; and
a second instruction group for designating, when the final recognized words are present, a search word from the final recognized words, retrieving a piece of information that corresponds to the search word from the stored pieces of information, and controlling the reproducing unit for reproducing the retrieved piece of information.

19. A reproducing method used in a reproduction system that includes:
a storing unit for storing a plurality of pieces of information that can be reproduced;
a combination information storing unit for storing a plurality of pieces of combination information relating to combination among words;
a reproducing unit for reproducing a piece of information designated from the plurality of pieces of information stored in the storing unit; and
a speech inputting unit for inputting a speech,
the reproducing method comprising steps of:
recognizing and decomposing the inputted speech into words;
determining whether combination among the recognized words is included in the combination information storing unit,
wherein, when the combination among the recognized words is included in the combination information storing unit, the recognized words are recognized as final recognized words,
wherein, when the combination among the recognized words is not included in the combination information storing unit, the recognized words are dealt with by one of two procedures, wherein in a first procedure the recognized words become tentative recognized words having information indicating that a degree of likelihood of the recognized words to the inputted speech is low, wherein in a second procedure the recognized words do not become the final recognized words;
designating, when the final recognized words are present, a search word from the final recognized words;
retrieving a piece of information that corresponds to the search word from the stored pieces of information; and
controlling the reproducing unit for reproducing the retrieved piece of information.
